(19) United States
(12) Patent Application Publication
(10) Pub. No.: US 2020/0039053 A1
(43) Pub. Date: Feb. 6, 2020

(54) Modular Manual Impacting System

(71) Applicant: Eric E. Reeves, Pelham, AL (US)

(72) Inventor: Eric E. Reeves, Pelham, AL (US)

(21) Appl. No.: 16/543,968

(22) Filed: Aug. 19, 2019

Related U.S. Application Data
(63) Continuation of application No. PCT/US2018/044694, filed on Jul. 31, 2018.
(60) Provisional application No. 62/538,984, filed on Jul. 31, 2017.

(51) Int. Cl. B25G 3/04; B68B 11/00; B25G 1/10

(52) U.S. Cl. CPC B25G 3/04; B25G 1/102; B68B 11/00

(57) ABSTRACT

A modular manual impacting system, and related methods, kits, adapters, and components. Multiple handles and multiple striking heads each have compatible quick-release mechanical connectors, so that different customized striking implements can be rapidly assembled, disassembled, and changed.

### CROSS-REFERENCE

Priority is claimed from U.S. 62/538,984, which is hereby incorporated by reference.

### BACKGROUND

The present application relates to impact stimulation devices, and more specifically to manually operated impact massage tools, methods, kits, and systems.

Note that the points discussed below may reflect the hindsight gained from the disclosed inventions, and are not necessarily admitted to be prior art.

### Impact Stimulation

Many different tools have historically been used for sensory stimulation of the skin and underlying tissue. Such impact stimulation devices have been used for sexual play, for punishment, for some types of massage, and for some types of religious rites. There are many varieties of such devices, including floggers, cats (like a flogger, but with cords instead of strips), rope's ends, thin and thick canes, birch twigs, whips, tawses, flails, etc. etc.

A single session may last for 30 minutes or more, so repetitive stress injury is always a consideration for the person wielding the floggers. To avoid repetitive stress injury, a comfortable fit which will assure optimal wrist operation is very helpful.

A complicating factor is that the position and kinetics of operation for different impact toys can be different. For example, some may require a light fast action, without great concern for accuracy; others may require a very carefully directed strike; and still others may require a very different full swing, to move a heavy bulk of material.

One important and basic technique in stimulation activities of the kind addressed here is rhythmic two-handed flogging, which is commonly referred to as Florentining. A rhythmic sequence of impact, at a tempo of e.g. 50 to 150 bpm, provides a steady stimulation to the person being impacted. Ergonomics are particularly important for Florentine flogging, to avoid excess stress on the operator.

### Modular Manual Impacting System

The present inventor has realized that the optimal trade off of swing weight, flexibility, and grip varies from user to user, from tool to tool, and even from session to session. Moreover, there are techniques which require a swivel joint, techniques which require that a swivel joint not be present, and techniques for which a swivel joint is optional.

According to some of the innovative teachings of the present application, a quick release joint is used to construct modular impact tools, by quick-connecting a selected one of many striking ends to a selected one of multiple possible handles. This permits the resulting tool to be optimal for the stimulus needed by the patient, as well as for the biomechanics of the person wielding the implement.

One important teaching, for some embodiments, is that the quick release joint should be double locking. Joints of this type are used, for example, for high pressure air hose connections, and can be procured off-the-shelf. Such joints are used, in the preferred embodiments described below, for mechanical linkage, and not for their intended function as pressure joints.

### BRIEF DESCRIPTION OF THE DRAWINGS

The disclosed inventions will be described with reference to the accompanying drawings, which show important sample embodiments and which are incorporated in the specification hereof by reference, wherein:

FIG. 1A schematically shows an assembled striking implement, and FIG. 1B shows the same implement disassembled, i.e. with its striking head separated from the handle.

FIG. 2 shows an exploded view of an example of a handle assembly.

FIG. 3 shows an elongated handle having quick-release connectors on both ends.

FIG. 4 shows an adaptor, which can be used to adapt three striking heads to a single handle, within the same modular family.

### DETAILED DESCRIPTION OF SAMPLE EMBODIMENTS

The numerous innovative teachings of the present application will be described with particular reference to presently preferred embodiments (by way of example, and not of limitation). The present application describes several inventions, and none of the statements below should be taken as limiting the claims generally.

The present application discloses new approaches to manual impacting for massage or sensory play.

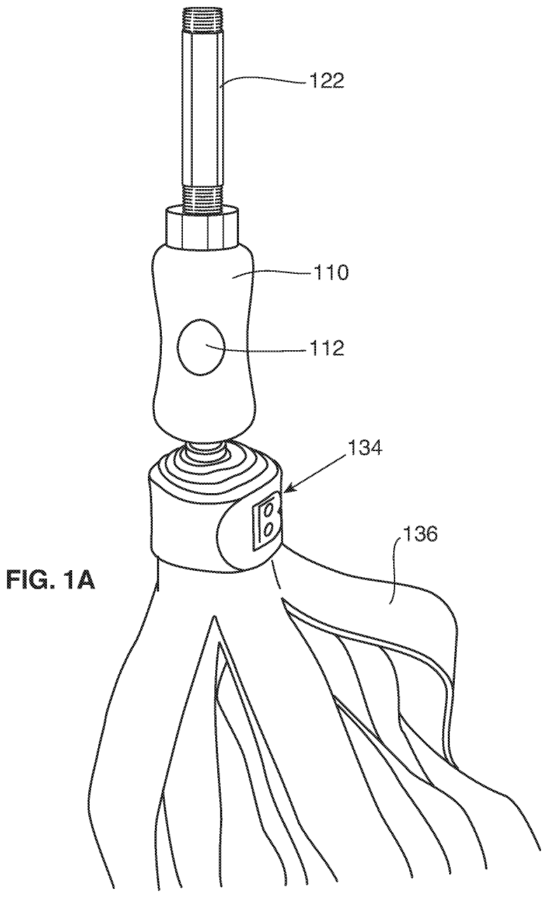

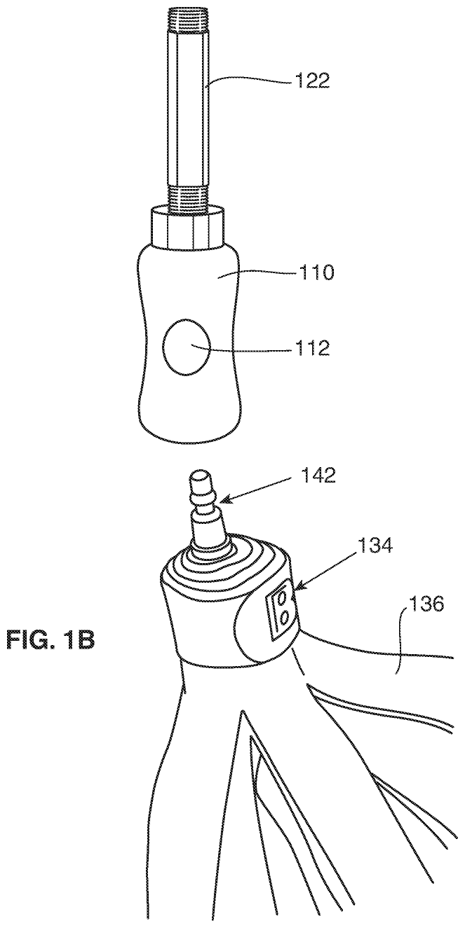

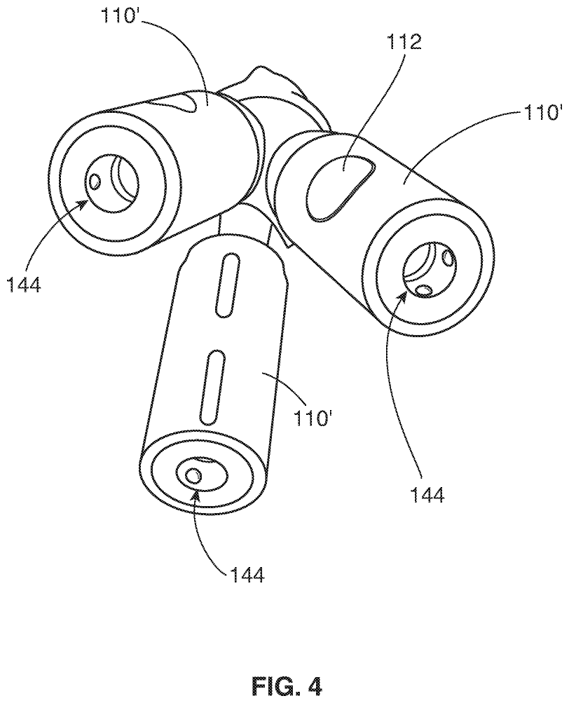

FIG. 1A schematically shows an assembled striking implement according to various disclosed innovations. A connector body 110 contains a female quick-release connector (not shown in this figure, but shown with reference number 144 in FIG. 4). The button 112 is the release for the connector. A handle core 122 provides a base for the grip portion of the handle.

As shown, the striking head includes tails 136 which are all connected to a head portion 134. The tails of the striking head are floppy (in this example), but the striking head is rigidly connected to the handle portion of the striking implement through a quick-release connector (not visible in this drawing). The tails 136 can be, for example, inch-wide strips of fairly thick leather. Many types and thicknesses of leather can optionally be substituted here.

Preferably the quick-release connector requires a two-stage release: when the release button 112 is pressed, the two pieces can be extended a few millimeters from their fully locked position, but cannot totally separate. This feature was apparently intended to avoid sudden release of air hoses, but functions differently in the example of FIG. 1A: the two-stage release not only provides extra rigidity, it also increases resistance to loosening over time, and also helps to avoid flying pieces if separation occurs accidentally during use.

FIG. 1B shows the implement of FIG. 1A disassembled, i.e. with its striking head separated from the handle. In addition to the components described above, the male quick-release connector 142 is now visible. The male connector 142, in this example, is firmly affixed to the head portion 134 of the striking head.

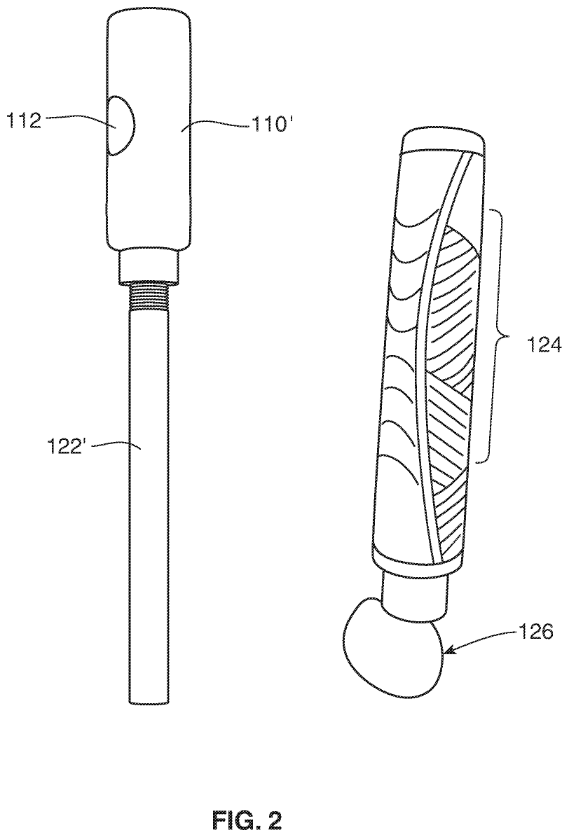

FIG. 2 shows an exploded view of an example of a handle assembly. In this example the handle core 122′ is longer than the handle core 122 shown in FIGS. 1A and 1B. A textured grip 124 fits over the handle core 122′, and a cap 126 fits onto the end of the handle core 122′. (Optionally, the cap 126 can be affixed to the end of the grip 124 rather than to the handle core 122′.) Preferably the grip 124 is made of a durable polymer. The cap 126 can be made of the same material, or of a different durable material. In this example, the grip 124 is grooved to avoid slippage in the operator's hand.

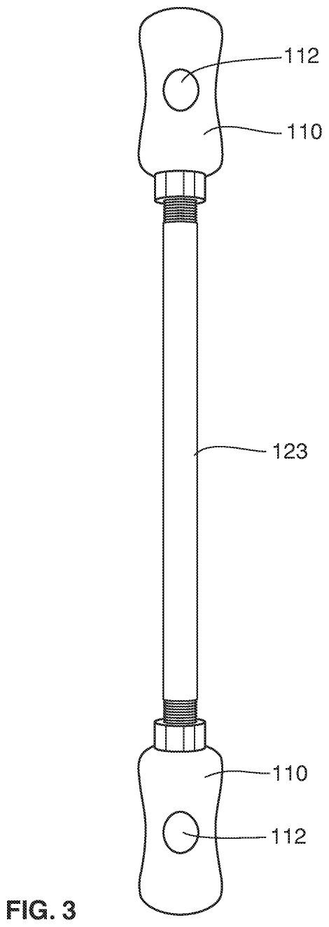

FIG. 3 shows an elongated handle having quick-release connectors 110 on both ends. Each connector 110 has its own release control 112, so that a striking head can be attached to one end or both. One innovative teaching is that such a longer double ended handle, with modular couplers on both ends, can be used to permit both two hand operation, as in a Moulinette move in quarterstaff or bo training, or simply to provide a greater active length for a tool with flexible ends.

FIG. 4 shows an adaptor, which can be used to adapt three striking heads to a single handle, within the same modular family. In this drawing the female quick-release connectors 144 are visible. These are the same connectors used in the examples of FIGS. 1A/1B, 2, and 3, but were not visible in those Figures. A male quick-release connector 142 is also attached to the adaptor, but is not visible in this drawing.

The examples of FIGS. 1A/1B and FIG. 2 use a single striking head assembly 142+134+136. However, if the adaptor of FIG. 4 (instead of the striking head assembly) is inserted into the handle, THREE striking head assemblies can be inserted into the female quick-release connectors. This means that the weight and swing weight of the resulting striking implement will be more than tripled, as compared to a striking implement which does not use the adaptor.

The adaptor of FIG. 4 can also be varied. Even an adaptor which does not include the three-into-one geometry of FIG. 4 will increase the swing weight, since (if the same tails 136 are used) the overall swinging length will be increased by the length of the adaptor.

Note that the positioning and kinetics of operation for different impact toys can be different. For example, some may require a light fast action, without great concern for accuracy; others may require a very carefully directed strike; and still others may require a very different full swing, to move a heavy bulk of material. The disclosed architecture permits rapid adjustment to “change gears” for such considerations.

The disclosed inventions also permit the same grip to be transferred between different kinds of tools, as well as between different weights and or lengths of tools. Just to give a few examples, the disclosed system can include shorter or longer tool portions for performing the functions of: canes, flexible canes, flails, bloggers, singletails, cat-o'-nine tails and the like, etc.

The handles, in this interchangeable system, can be curved as well as straight, and can be tapered in either direction. Some can have intermediate swells or finger grooves, some can have enhanced-grip or cushioning material which adds traction or as questioning, some can have different weightings and lengths, and different colors or decorations can also be used.

The ergonomics of wielding striking appointments are important not only for wrist longevity, but also to avoid shoulder strain. Part of a good striking motion is a balance between the “swing weight” of the striking head itself and the distribution of mass in the handle. (“Swing weight” measures the inertial term in oscillation of an implement around a pivot point, and is used to compare equipment within several different sports.)

With a rigid handle, the distribution of mass to the rear of the pivot point in the wielder's hand is part of the dynamic system. Thus changing grips can be used to find the appropriate balance for different striking heads.

Optionally, some handles can also include electrical connectors, e.g. at the end opposite to the modular attachment point. For example, a BNC connector can be included in the bottom of select grips for the use of connecting electrical impulse, such as from a Violet Wand.

Another advantage of this interchangeable system is that a new type of implement can be tried out easily, without committing to purchase of the finest materials. Many implements are made of exotic leathers which are quite expensive, and this makes it more difficult for a user to try out a new design which he thinks he might like. For example, someone who wants to try out a horse hair flogger might first purchase a cheap implement with synthetic fibers, to see if the basic movement and impact are desirable. If the “trial run” implement seems to work well, then a more expensive purchase can follow.

In one class of embodiments, an electrical connector is included in some of the handle components. (Preferably some have this, and some do not.) This can be, for example, a BNC connector can be located at the bottom of select grips for the use of connecting electrical impulse sources, such as from a Violet Wand.

Another advantage of the disclosed inventions is better cleanliness. Since striking heads can be rotated out of service after use, more complicated methods of sterilization or disinfection can be used to avoid possible transmission of pathogens. The risk considerations are unlike mainstream medical uses in that users often do not have the training (nor budget, nor quantity of spare implements) to do really thorough disinfection. Unlike any other field of use, with manual impacting some degree of sterilization is highly desirable (due to the possible presence of blood or plasma splatter or aerosols).

In a sample implementation, the handle construction is composed of several parts. (All parts can be exchanged due to customer request.) The general design starts with a length of PVC pipe corresponding to the finished length of the handle. One end of the pipe is threaded. A foam or composite sleeve is slid over the pipe and glued into place. A butt cap of the same material is glued to the back end of the handle. On the front end, the threaded pipe end is screwed into a premade Female Safety Coupler and secured.

The flogger, dragon tail, and other attachments are made with a Female NPT industrial plug, or other comparable part, and the base of the head to be attached. The leather is wrapped around the plug and then held in place with an industrial band strap to fully secure the parts.

This type of construction allows for the end user to mix and match a series of different handles with a series of heads making this system a fully interchangeable system of impact toys. Compatible dimensions of both the handle construction and the industrial plug built into the base of the head allow for the interchanging of handles and heads.

According to some but not necessarily all embodiments, there is provided: a kit for manual impact stimulation, comprising: multiple different handles; and multiple different striking heads; wherein multiple ones of the handles each include at least one quick-release connector having a first gender; and wherein multiple ones of the striking heads each include at least one quick-release connector which is mechanically compatible with the connectors in the handles, and which has a second gender which is opposite to the first gender; whereby customized operable striking implements can be rapidly assembled, disassembled, and changed, to suit the ergonomic needs of the operator and the stimulation needs of the patient.

According to some but not necessarily all embodiments, there is provided: A kit for manual impact stimulation, comprising: multiple different handles, each including at least one quick-release connector having a first gender; multiple different striking heads, each including at least one quick-release connector which is mechanically compatible with the connectors in the handles, and which has a second gender which is opposite to the first gender; and at least one adapter which includes quick-release connectors of both genders; whereby customized operable striking implements can be rapidly assembled, disassembled, and changed, with or without the adapter interposed, to suit the ergonomic needs of the operator and the stimulation needs of the patient.

According to some but not necessarily all embodiments, there is provided: A method of performing manual impact stimulation, comprising the actions of: assembling a first one of multiple handles to a first one of multiple striking heads by mating a quick-release connector in the first handle to a compatible quick-release connector in the first striking head, to thereby form a first operable striking implement; operating the first striking implement; detaching the first striking head, and attaching a second striking head to the first handle or another handle to thereby form a second operable striking implement; and operating the second striking implement, while the first striking head is being sterilized.

According to some but not necessarily all embodiments, there is provided: A modular manual impacting system, and related methods, kits, adapters, and components. Multiple handles and multiple striking heads each have compatible quick-release mechanical connectors, so that different customized striking implements can be rapidly assembled, disassembled, and changed.

### Modifications and Variations

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

In one sample embodiment, the double-retention quick-release connectors can be, for example, Interstate Pneumatics CG441PB (male) and CG440PB (female)¼ Inch Universal Push Button Aluminum Couplers from Interstate Pneumatics.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

1-6. (canceled)

7. A kit for manual impact stimulation, comprising:
multiple different handles, each including at least one quick-release connector having a first gender;
multiple different striking heads, each including at least one quick-release connector which is mechanically compatible with the connectors in the handles, and which has a second gender which is opposite to the first gender; and
at least one adapter which includes quick-release connectors of both genders;
whereby customized operable striking implements can be rapidly assembled, disassembled, and changed, with or without the adapter interposed, to suit the ergonomic needs of the operator and the stimulation needs of the patient.

8. The kit of claim 7, wherein the quick-release connectors require two-stage release.

9. The kit of claim 7, wherein the first gender is male, and the second gender is female.

10. The kit of claim 7, wherein every quick-release connector of the first gender is compatible with every quick-release connector of the second gender.

11. The kit of claim 7, wherein at least one of the handles includes two quick-release connectors, of the first gender, at opposite ends of the handle.

12. The kit of claim 7, wherein at least one of the handles includes a quick-release connector which prevents swiveling, and another of the handles includes a quick-release connector which allows swiveling.

13. The kit of claim 7, wherein the adapter includes more than two of the quick-release connectors, and can be connected to multiple striking heads in parallel.

14. The kit of claim 7, wherein the adapter includes three of the quick-release connectors at one end thereof.

15. A method of performing manual impact stimulation, comprising the actions of:
assembling a first one of multiple handles to a first one of multiple striking heads by mating a quick-release connector in the first handle to a compatible quick-release connector in the first striking head, to thereby form a first operable striking implement;
operating the first striking implement;
detaching the first striking head, and attaching a second striking head to the first handle or another handle to thereby form a second operable striking implement; and
operating the second striking implement, while the first striking head is being sterilized.

16. The method of claim 15, wherein the quick-release connectors require two-stage release.

17-18. (canceled)

19. The method of claim 15, wherein at least one of the handles includes a quick-release connector which prevents swiveling, and another of the handles includes a quick-release connector which allows swiveling.

20. The method of claim 15, wherein the first striking head is sterilized merely by prolonged exposure to ambient air.
